(19) United States
(12) Patent Application Publication
(10) Pub. No.: US 2005/0183932 A1
(43) Pub. Date: Aug. 25, 2005

(54) Driving mechanism for the traction-exerting component particularly of a conveyor device

(75) Inventor: Karl Angleitner, Hohenzell (AT)

Correspondence Address: COLLARD & ROE, P.C., 1077 Northern Boulevard, Roslyn, NY, 11576, US

(73) Assignee: TGW Transportgerate GmbH & Co. KG

(21) Appl. No.: 11/055,748

(22) Filed: Feb. 10, 2005

(30) Foreign Application Priority Data
Feb. 11, 2004 (AT) A 201/2004

(51) Int. Cl. B65G 35/00

(52) U.S. Cl. 198/618

(57) ABSTRACT

The invention relates to a driving mechanism (11) for the traction-exerting component (13) of a conveyor device (1), with a frame (10); at least one reversing wheel (15a, 15b) and one driving wheel (17) supported on said frame; an endlessly revolving, flexible traction-exerting component (13) guided around the reversing and driving wheels (15a, 15b; 17) and having a pulled strand and a returning strand; a tensioning device (18); as well as a setting device comprising the tensioning device. The tensioning device (18) has two support bodies arranged one behind the other in the direction of revolution of the traction-exerting component (13), said support bodies being adjustable against one another, and tensioning elements each supported on said support bodies. With its pulled strand, the traction-exerting component (13) is guided around one of the tensioning elements, and with its returning strand around the other tensioning element, as well as around the reversing and driving wheels (15a, 15b; 17), whereby tensioning forces directed against each other are admitted to the tensioning elements, which are arranged spaced from each other; and whereby the spacing is adjustable to a limited extent via the at least one setting element.

### CROSS REFERENCE TO RELATED APPLICATIONS

Applicant claims priority under 35 U.S.C. §119 of AUSTRIAN Patent Application No. A 201/2004 filed on 11 Feb., 2004.

### BACKGROUND OF THE INVENTION

1. Field of the Invention

The invention relates to a driving mechanism for the traction-exerting component particularly of a conveyor device, comprising a frame; at least one reversing wheel and one driving wheel supported on said frame; an endlessly revolving flexible traction-exerting conveyor component that is reversible with respect to its direction of revolution and has a pulled strand and a returning strand; a tensioning device, as well as at least one setting element, such tensioning device comprising two support bodies arranged one after the other in the direction of revolution of the traction-imparting component, and being adjustable relative to each other; and tensioning elements each being supported on said support bodies, whereby tensioning forces are directed at each other and admitted to said tensioning elements, and the traction-imparting component is guided with its pulled strand around one of the tensioning elements, and its returning strand around the other the tensioning element and as well as around the reversing and driving wheels and/or also around at least one additional reversing wheel supported on the frame; and a conveyor device for conveying piece goods along a transport line via the traction-exerting component of at least one driving mechanism for driving said traction-imparting component.

2. The Prior Art

It is known that driving mechanisms for traction-imparting conveyor components equipped with an endlessly revolving, flexible traction-exerting component, for example in the form of a band, belt, chain and the like, have to be equipped with a tensioning device so as to ensure that the endless, traction-exerting component has the required tension under any operating conditions and will supply the initial tension required for transmitting the peripheral force of the driving wheel, and thus maintain the friction grip between the traction-exerting component and the driving wheel. Any lengthening or extension of the endless traction-exerting component thus has an only insignificant effect on the peripheral force transmittable from the driving wheel to the traction-exerting component.

A tensioning device for the traction-exerting component, in particular a conveyor belt that is guided around a pair of reversing wheels, driving wheels and tensioning wheels, is known from DE 43 91 686 T1. In said tensioning system, a pair of tensioning wheels is supported freely rotating on a guide carriage (plate) that is adjustable vis-a-vis the frame of the conveyor device by means of a setting cylinder acted upon by a pressure medium. Said tensioning wheels are arranged at a fixed spacing from each other in the tensioning direction of the tensioning wheels. The guiding carriage is adjustably supported along a slotted link track in the frame. When the guide carriage is adjusted in the direction of the setting cylinder, the traction-exerting component is acted upon by tensioning forces directed in the same direction via the tensioning wheels that are synchronously adjusted relative to one another as well, and thus tensioned. The endless traction-exerting component is guided from one of the reversing wheels via the first tensioning wheel that is supported on the guiding carriage, and subsequently via the first driving wheel to the second tensioning wheel, which is disposed downstream in the direction of revolution and supported above the first driving wheel on the guide carriage; and finally via the second driving wheel, whereupon in the normal operation of the conveyor device (conveyance of piece goods from the left to the right) with respect to the driving wheels, one of the tensioning wheels is in contact with the pulled strand of the traction-exerting component, and in the reversed operation (conveyance of piece goods from the right to the left), both tensioning wheels are in contact with one of the pulled strands of the traction-exerting component with respect to the driving wheels. This requires the tensioning force acting on the tensioning wheels to be rated unnecessarily high, and the efficiency of the setting cylinder employed in such a system has to be rated high accordingly.

A conveying system, in particular a belt conveyor comprising a tensioning device is known also from EP 1 260 460 A1. Said conveyor device comprises an endlessly revolving, flexible traction-imparting component guided around two reversing wheels supported freely rotating on a frame; a driving wheel; as well as a tensioning device contacting the traction-exerting component. Said tensioning device comprises tensioning wheels arranged at a fixed spacing from each other in the direction of revolution of the traction-exerting component via a guide carriage, and are freely rotationally supported on said carriage. The guide carriage is realized in the form of a rod or cable. For compensating any change in the length of the endless traction-exerting component, the two tensioning wheels, which are rigidly coupled with each other, are adjusted vis-a-vis the stationary driving wheel in the vertical and/or horizontal directions.

Furthermore, a driving mechanism for the traction-imparting component of a conveyor device is known from WO 88/07489 A1, which is comprised of an endlessly revolving traction-exerting component, particularly a chain with a returning strand and a pulled strand, and a tensioning device with at least one tensioning element, to which tensioning force is admitted in the direction of the traction-exerting component. The latter is guided around a reversing wheel rotationally supported on a frame of the driving mechanism for the traction-exerting component, via a running rail secured on the frame; a curved reversing component; and around a driving wheel. The tensioning device is arranged in the returning strand of the traction-exerting component between the driving wheel and the reversing wheel disposed opposite the reversing component, and has a unilaterally acting locking device that blocks any motion of displacement of the tensioning element directed against the tensioning force. This known driving gear for the traction-exerting component can be employed for a reversed operation only to a limited extent because after the direction of revolution of the traction-exerting component has been reversed from normal to reverse operation, the tensioning element is in contact with the pulled strand of the traction-exerting component, and the tension in the traction-exerting component can be safely maintained only if provision is made for an additional, unilaterally acting locking device.

Furthermore, a driving mechanism for the traction-exerting component of a conveyor is known from GB 619 075 A. Said driving mechanism is comprised of a frame; two reversing and driving wheels supported on said frame; two tensioning wheels; as well as an endlessly revolving traction-exerting component guided around said tensioning wheels. The latter wheels are driven and supported on support bodies that are adjustable relative to one another. An adjusting device is allocated to each of the support bodies, via which the latter are manually adjusted from time to time by admitting tensioning forces directed against each to the traction-exerting component, and the latter is tensioned in this manner. No provision is made in GB 619 075 A for any automatic readjustment of the tensioning wheels for maintaining the tensioning forces.

DE 11 64 926 B discloses a driving mechanism for the traction-exerting component of as conveyor system, where said component is guided via two driving wheels and three reversing wheels. Two of the reversing wheels are supported on support bodies that can be adjusted in relation to one another, whereas the third reversing wheel is stationary. The support bodies are provided in the form of tensioning carriages that can be displaced one after the other on a common track, and are separately pulled by their individual cables. The cables are wound on drums driven by tensioning motors.

Finally, a conveyor system with driving gear for the traction-exerting component is known from DE 29 23 891 A. Said driving gear comprises a traction-exerting component; a horizontally displaceable tensioning carriage with reversing wheels arranged at its ends; two driving wheels; and a stationary third reversing wheel, whereby the traction-exerting component is guided with respect to its direction of revolution from the driving wheels to the first reversing wheel on the tensioning carriage, and via the third reversing wheel back to the second reversing wheel mounted on the tensioning carriage.

### SUMMARY OF THE INVENTION

The present invention is based on the problem of providing an improved driving mechanism of the traction-exerting component of a conveyor that is characterized by its structure and operable in the reverse operation with the same conveying properties as in the normal operation.

The problem of the invention is resolved in that the support bodies are coupled with each other in terms of movement via the setting elements. The benefits so gained are surprising in that both in the normal (clockwise operation of the traction-exerting component) and the reverse operations (anticlockwise operation of the traction-exerting component), a tensioning element is in contact with the pulled strand, whereas the other tensioning element is in contact with the returning strand, and in that the tension applied to the traction-exerting component on the returning strand is automatically maintained irrespectively of in which mode of operation or direction of revolution the traction-exerting component is operating. If a flat type or a V-belt or some other type of belt or band or a cable or the like is employed as the traction-imparting component, it is now possible to transmit the peripheral force in a simple manner from the driving wheel to the traction-exerting component free of slip. If the traction-exerting component is realized in the form of a chain, toothed belt and the like, the tension in the traction-exerting component is automatically maintained, and vibration of the chain causing wear is avoided. In addition, lengthening of the traction-exerting component caused by the operating load, as well as also extension of said component due to aging in the course of operation of the driving mechanism for the traction-exerting component is continually compensated via the tensioning element contacting the returning strand, and the tension in the traction-exerting component remains automatically maintained without requiring re-tensioning from time to time. Manual retensioning of the traction-exerting component at periodic maintenance time intervals can be avoided in this way. The tension in the traction-exerting component is generated in a beneficial way via at least one setting element arranged on the frame of support bodies that are supported in a floating manner.

An embodiment of the driving mechanism for the traction-exerting component, where the support bodies each form a stop surface on their sides facing away from each other, and the support body is kept supported and positioned with its stop surface against a support element, with the tensioning element being in contact with the pulled strand, is advantageous as well, because one of the support bodies and the tensioning element supported on the latter is kept positioned against the support elements by the action of the force in the pulled strand of the traction-exerting component, whereas the opposite tensioning element contacting the returning strand is acted upon by the tensioning force directed at the tensioning element that is kept positioned, said tensioning force exceeding the tensioning force acting in the returning strand and tightening the traction-imparting component.

Owing to the fact that the tensioning elements are arranged spaced from each other, whereby the spacing can be adjusted to a limited extent by at least one setting element, collision between the tensioning elements is avoided.

Due to the fact that the support bodies are realized in the form of guide carriages and arranged separated from one another, and that the tensioning elements are adjustable via the support bodies along a slotted-link track extending over part of the length of the driving mechanism of the traction-exerting component, the benefit gained is that reliable guiding of the support bodies along the slotted link track on the frame is ensured.

The further developed embodiment of the driving mechanism for the traction-exerting component, where the support bodies are formed by pivot-mounted rocker levers swinging around axles extending perpendicular to the longitudinal expanse of said driving mechanism, is beneficial as well in that such a design leads to small dimensions of the construction of the tensioning device.

Different embodiments and arrangements of the tensioning elements are specified in claims 6 to 8.

Owing to the fact that the distance of adjustment of the support bodies is limited by two stop elements that are arranged spaced from one another in the direction of adjustment of said support bodies, whereby the stop elements are mounted stationary on the frame, and the support bodies are adjustably supported on the frame between the stop elements, the maximal distance of adjustment of the support bodies is limited via the stop elements, so that any unnecessary adjusting movement of the guiding carriages is avoided when the direction of revolution is changed, or when switching from the normal to reverse operation.

The further developments of the invention according to claims 10 to 19 are beneficial as well in that if any operationally permissible extension or lengthening of the traction-exerting component along the driving mechanism of the latter due to the weight of the transported piece goods, is exceeded, the stop element is readjusted in the same sense as the coupling element in the direction of the support bodies disposed adjacent to the resetting device, and the adjustment distance limited by the stop elements is shortened in this way for the support bodies, the latter being adjustable along the slotted link track. Shortening of the adjustment distance also reduces the adjustment spacing between the stop surface of the respective support body and the stop element, so that the kinetic energy of the support bodies in the direction of the stop element can rise only to a limited degree as said bodies are being adjusted. This permits gentle treatment of the tensioning system, the traction-exerting component and the frame. In addition, even with very long conveyor systems and traction-exerting components employed in such systems, at least one of the stop elements can be adjusted depending on the maximum elongation for which such traction-exerting components are rated. This means, furthermore, that frequent switching of the conveyor system from normal to reverse operation will not result in any adverse effects on the conveying properties and in particular on the peripheral force, the conveying rate and the useful life of the conveyor system.

Advantageous designs of the setting element are specified in claim 20.

The further development of the driving mechanism of the tractive component, where each stop element is provided with a damping element such as a rubber buffer or fluid shock absorber, is beneficial in that at least a major part of the impact energy can be absorbed as the support body is impacting the stop element.

An advantageous arrangement of the damping elements is described for the embodiment according to claim 22.

The further development of the embodiment of the driving mechanism of the traction-exerting component, in which at least one adjustment speed limiter, particularly a fluid cylinder-and-piston arrangement is provided between the frame and the respective support body, is beneficial as well in that the adjustment speed of the support bodies is braked in a controlled way after switching from normal to reverse operation, and the impact energy generated as the support body is impacting the stop element with its stop surface, is significantly reduced.

According to claim 24, the setting element forms at the same time a damping element, which is advantageous in that the impact energy generated as the support body is impacting with its stop surface the stop element that is stationary versus said stop surface, is partly absorbed by the setting element, and the tensioning element in contact with the returning strand remains substantially unaffected by stress.

The embodiments of the driving mechanism of the traction-exerting component, where the latter is guided starting from the driving wheel via the additional reversing wheel-if any and one of the tensioning elements, and via two reversing wheels arranged adjacent to the traction-exerting component in the transport plane, and subsequently via the other tensioning element back to the driving wheel, whereby one of the tensioning elements is in contact with the pulled strand, and the other tensioning element with the returning strand; and/or the two support bodies or tensioning elements of the tensioning device are arranged next to each other in a plane extending below the pulled strand and substantially parallel to the plane extending parallel to the transport plane of the traction-exerting component, as well as between the two reversing wheels for the strand pulled around said reversing wheels; and/or the radii of the tensioning elements and the additional reversing wheel, and also of the driving wheel are identical; and/or the axial spacing between the tensioning elements, particularly of tensioning wheels disposed parallel to the transport plane of the traction-exerting component, is dimensioned smaller than the axial spacing between the additional reversing and driving wheels disposed parallel to the transport plane of the traction-exerting component, are advantageous in that a particularly efficient driving concept is created this way in a simple manner, and the tensioning system and also the additional reversing and driving wheels are accommodated below the plane of transportation in the space that is available between the set-up surface of the conveyor system and the driving mechanism for the traction-exerting component in any case.

According to the embodiment of the driving mechanism of the traction-exerting component where the driving wheel and the first tensioning element, and the additional reversing wheel and the second tensioning element are arranged in pairs one on top of the other, and the looping angle of the reversing and driving wheels as well as of the tensioning elements through the driving mechanism amounts to about 180° in each case, a high peripheral force or driving output transmittable to the traction-exerting component is achieved, which permits also transporting piece goods with particularly high weights.

The embodiment of the driving gear for the traction-exerting component where the additional reversing wheel is supported on the frame on a tensioning bearing that is adjustable versus the tensioning element in the same direction parallel to the tensioning direction, facilitates repair or installation work on the driving mechanism for the traction-exerting conveyor component.

Owing to the fact that in addition to the driving wheel, at least one of the tensioning wheels and/or the additional reversing wheel are driven, it is possible to raise the peripheral force or driving output transmittable from the driving wheel and/or driven tensioning wheel and/or additional reversing wheel to the traction-exerting component.

Different embodiments of the traction-exerting component are specified in claim 31.

Finally, the problem of the invention is resolved also by the features specified in claim 32. It is advantageous that piece goods can be transported on the conveyor device selectively from the left to the right and from the right to the left with no change in the conveying properties, in particular in the peripheral force, conveying rate and the like, and that as a result of the compact structure of the tensioning system, trouble-free operation of the conveyor system is achieved without the necessity of manual re-tensioning from time to time.

### BRIEF DESCRIPTION OF THE DRAWINGS

The invention is explained in greater detail in the following with the help of the exemplified embodiments shown in the drawings, where

FIG. 1 is a side view and simplified representation of the conveyor device as defined by the invention, and of the driving mechanism of the traction-imparting component as defined by the invention.

FIG. 2 is a top view and simplified representation of the conveyor device according to FIG. 1.

FIG. 3 is a perspective view and simplified representation of a first design variation of the driving mechanism for the traction-exerting conveyor component as defined by the invention, with the endless traction-exerting component driven in a first direction of revolution.

FIG. 4 is a perspective view and simplified representation of the driving mechanism for the traction-exerting conveyor component according to FIG. 3, where the endless traction-exerting conveyor component is driven in a second direction of revolution.

FIG. 5 is a perspective view and simplified representation of another design variation of the driving mechanism of the traction-exerting conveyor component as defined by the invention.

FIG. 6 is a perspective view and simplified representation of the driving mechanism of the traction-exerting conveyor component according to FIG. 3, with a resetting device for readjusting a first stop element in the direction of a second stop element disposed opposite the first one.

FIG. 7 is an enlarged and partly sectional side view of a cutout from FIG. 6, showing the resetting device.

FIG. 8 is a side view and simplified representation of another embodiment of the resetting device for the stop element in its starting position.

FIG. 9 is a side view and simplified representation of the readjusting device according to FIG. 8 in its first position of actuation.

FIG. 10 is a side view and simplified representation of the resetting device according to FIG. 8 in its second position of actuation.

FIG. 11 is a perspective view and simplified representation of a part area of another design variation of the driving mechanism of the traction-exerting conveyor component as defined by the invention, with another design of the tensioning device.

FIG. 12 is a side view and simplified representation of the driving mechanism for the traction-exerting component according to FIG. 4, with yet anther design of the tensioning device equipped with two adjustment speed limiters.

FIG. 13 is a side view and simplified representation of a last design variation of the driving mechanism for the traction-exerting component as defined by the invention, with yet another design of the tensioning device; and

FIG. 14 is a top view and simplified representation of the tensioning device according to FIG. 13.

### DETAILED DESCRIPTION OF PREFERRED EMBODIMENTS

It is noted by way of introduction that in the different exemplified embodiments described herein, identical components are provided with identical reference numbers or identical component designations, whereby disclosures contained throughout the specification are applicable in the same sense to identical components with identical reference numbers or identical component designations. Furthermore, data selected in the specification for positions such as, for example top, bottom, lateral etc., relate to the directly described and shown figure, and, where a position has changed, have to be applied to the new position in the same sense. Moreover, individual features or combinations of features in the various exemplified embodiments shown and described herein may represent independent inventive solutions or solutions as defined by the invention.

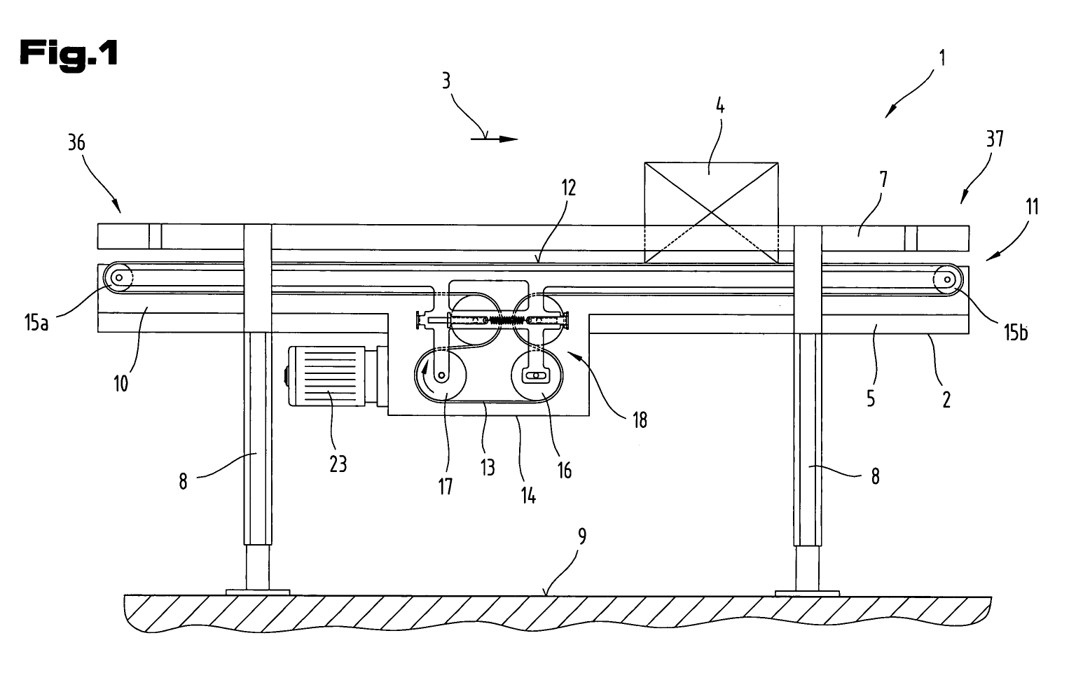

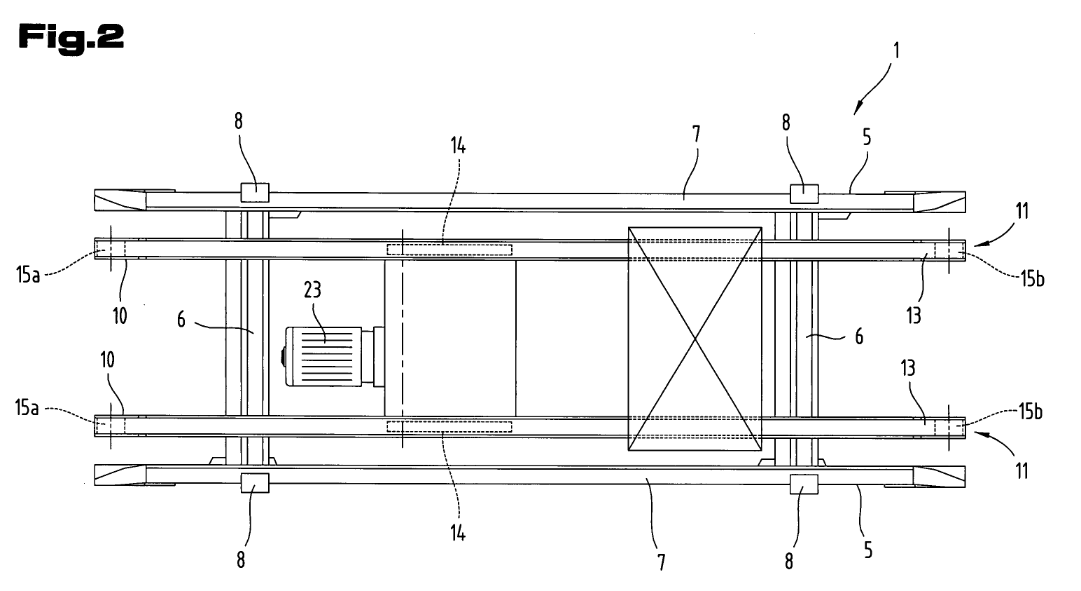

The jointly described FIGS. 1 and 2 show various simplified views of a possible design variation of a conveyor device 1, particularly a two-lane conveyor. The conveyor device 1 comprises a support frame 2 with the side components 5 limiting the conveyor device 1 laterally and extending in the direction of conveyance of the piece goods 4 as indicated by arrow 3. Said side components are connected with each other via a plurality of the crossties 6 which, viewed in the direction of transport according to arrow 3, are arranged spaced from each other and are thus kept apart. On each of the opposite side components 5, provision is made for a lateral guide rail 7, which is extending in the direction of transport indicated by arrow 3, and secured on said lateral components. The piece goods 4 are guided via said lateral guide rail along a path of transport laterally formed between said lateral guide rails. Via the support feet 8, which are connected with the crossties 6, the conveyor device 1 is supported on a horizontal set-up surface 9, for example the floor of a manufacturing plant.

FIG. 2 shows that the conveyor device 1 has the two driving mechanisms 11 for driving the traction-imparting conveyor components. Said driving mechanisms extend parallel to each other in the direction of transport indicated by arrow 3 and are each supported on the support frame 2 via a frame 10. The conveyor device 1 has a horizontal transport plane 12 extending parallel to the set-up surface 9. Said plane of transport is formed by the surfaces of the pulled strands of the two traction-exerting components 13, which extend parallel next to each other and spaced from each other. The driving mechanisms 11 for the traction-exerting components each comprise a driving station 14, whereby the driving wheels 17 described in the following are rigidly connected with each other for joint rotation via a common drive shaft shown by dash-dotted lines, and are coupled to a drive 23. Different embodiments of the driving mechanisms 11 for the traction-exerting components are described in greater detail in connection with the following figures.

The traction-exerting components 13 are designed endless and each guided around the reversing rollers 15a, 15b, which are arranged adjacent to the transport plane 12 and mounted on the face-side ends of the conveyor device 1. The endless traction-exerting components 13 are realized, for example in the form of a belt. It is also possible within the meaning of the invention to employ as the endless traction-exerting component 13 or conveying means elements such as toothed and flat belts, chains, cables, bands and the like. Accordingly, the conveyor device 1 may form a band or cable conveyor or the like as well.

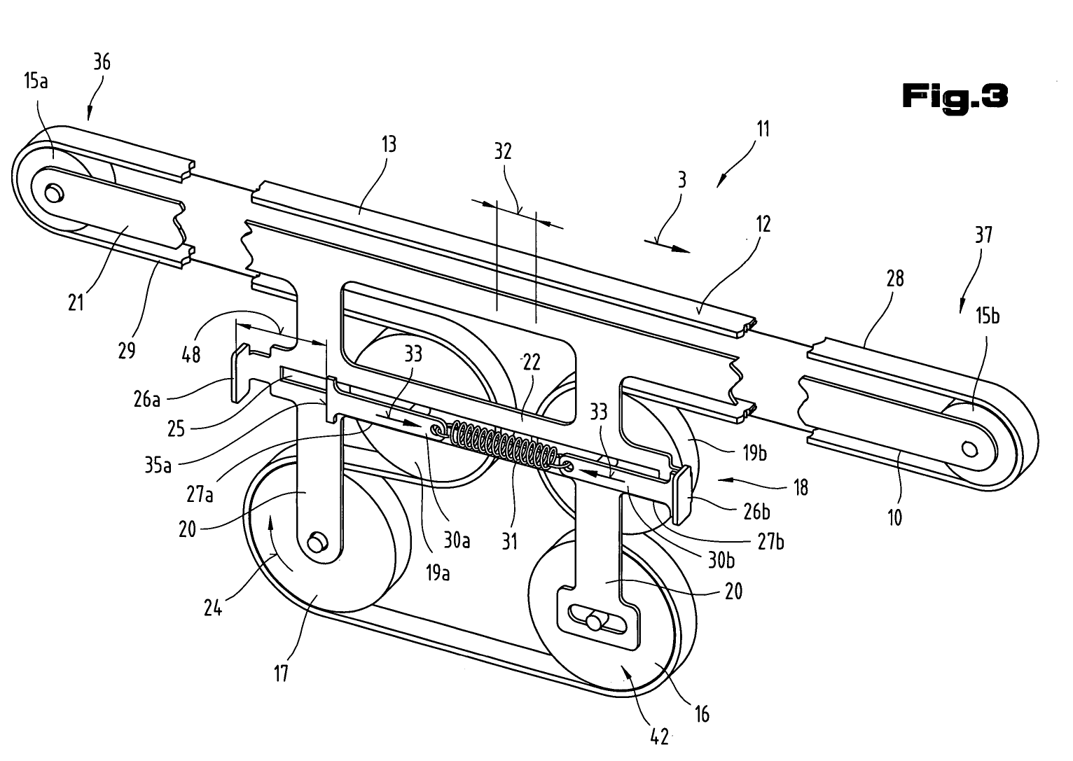

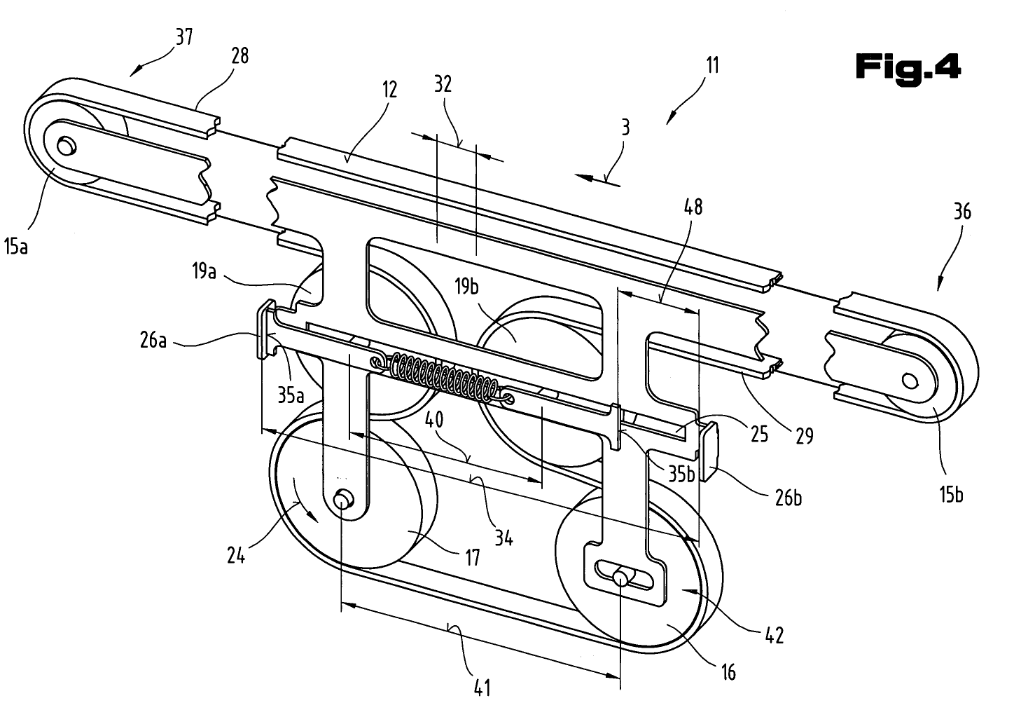

The jointly described FIGS. 3 and 4 show a perspective, simplified view of a design variation of the driving mechanism 11 of the traction-exerting conveyor component as defined by the invention. On the frame 10 secured on the support frame 2 of the conveyor device 1, the driving mechanism 11 is comprised of at least one traction-exerting component 13; a pair of reversing wheels 15a, 15b, which are arranged spaced from each other in the transport direction indicated by arrow 3 and disposed adjacent to the transport plane 12; an additional reversing wheel 17; a driving wheel 17; as well as a tensioning device 18 with the two tensioning elements 19a, 19b. Said tensioning device is described in greater detail further below. The traction-exerting component 13, in particular a belt, band and the like, is guided around the two reversing wheels 15a, 15b and the two tensioning elements 19a, 19b, as well as around the reversing and driving wheels 16 and 17, respectively. The additional reversing and driving wheels 16 and 17, respectively, and the tensioning device 18 are combined in the driving station 14 as show in FIG. 1.

In a preferred embodiment, the frame 10 is formed by a shaped sheet metal construction and comprises between the two reversing wheels 15a, 15b the two support legs 20, which are arranged spaced from each other in the longitudinal expanse of the driving mechanism 11; aligned approximately perpendicular to the transport plane 12; and comprise a support arm 21 connecting the support legs 20 with each other and extending laterally on said legs in opposite directions over approximately the total length of the driving mechanism 11; as well as a connecting bridge 22 extending between the support legs 20 substantially parallel to the transport plane 12. The reversing wheels 15a and 15b are freely rotationally supported on the opposite, free ends of the support arm 21. Likewise, the additional reversing and driving wheels 16 and, respectively, 17, each are rotationally supported on the free end of the support legs 20. The at least one driving wheel 17 is coupled to a drive 23 shown in FIGS. 1 and 2, particularly an electric motor such as a synchronous or asynchronous motor and the like with a reversible driving direction. This means that the direction of rotation-indicated by arrow 24—of the traction-imparting component 13 can be selectively changed depending on the desired direction of transport—according to arrow 3—of the piece goods 4 (see FIG. 1) from clockwise as shown in FIG. 3, to anticlockwise as shown in FIG. 4. In connection with the present embodiment of the traction-exerting component 13 in the form of a belt, particularly a flat belt, the peripheral force is exclusively transmitted from the driving wheel 17 to the traction-exerting component 13 via friction grip, and depending on the looping angle of the traction-exerting component 13 around the driving wheel 17, and the coefficient of friction between the driving wheel 17 and the traction-exerting component 13, the peripheral force or driving output transmittable to said traction-exerting component 13 can be adapted to various weights of the piece goods 4 to be conveyed in the given case of application.

On the frame 10, particularly on the connection bridge 22, provision is made for a slotted link track 25 in the form of a longitudinal guide, particularly a longitudinal slot extending parallel to the direction of transport 12 in the direction of the longitudinal expanse of the driving mechanism 11, as well as for the two stop elements 26a, 26b, which vertically protrude from the upwards projecting support legs 20, extending the connecting bridge 22, and protrude into the path of adjustment of the support bodies 27a, 27b of the tensioning device 18, which are described in greater detail further below. Said stop elements 26a and 26b are connected with the frame 10 and are particularly forming one piece with the latter.

The figures show that the two tensioning elements 19a, 19b are disposed in a plane extending below the pulled strand 28 (load strand) of the traction-exerting component 13 substantially parallel to the transport plane 12 between the reversing wheels 15a, 15b, and are supported on the frame 10 and adjustable to a limited extent along the slotted link track 25 via the support bodies 27a, 27b. The driving wheel 17 and the first tensioning element 19a, and the additional reversing wheel 16 and the second tensioning element 19b, are arranged in pairs one on top of the other, and the looping angle of the traction-exerting component 13 on the driving and reversing wheels 16 and 17, respectively, as well as on the tensioning elements 19a and 19b amounts to about 180° in each case.

With its outer surface facing away from the reversing wheels 15a and 15b, the pulled strand 28 forms the transport plane 12 and serves for conveying the piece goods 4 along the line of transport of the conveyor device 1, as shown in FIGS. 1 and 2. With its pulled strand 28, the traction-exerting component 13 guided and slidingly supported on a guiding section (not shown in detail) extending parallel to the transport plane 12 and below the pulled strand 28. Said guiding section extends between the reversing wheels 15a and 15b over approximately the entire length of the conveyor device 1, and is secured on the frame 10.

According to FIG. 3, the traction-exerting component 13 is guided in its direction of revolution—as indicated by arrow 24—from the driving wheel 17 via the first tensioning element 19a and the two reversing rollers 15a, 15b, and subsequently via the second tensioning element 19b and the additional reversing wheel 16 back to the driving wheel 17, whereby the pulled strand 28 of the traction-exerting component 13 is consequently running from the reversing rollers 15a, 15b via the second tensioning element 19b and the additional reversing wheel 16 up to the driving wheel 17, whereas the returning strand 29 (empty strand) of the traction-exerting component 13 is running from the driving wheel 17 via the first tensioning element 19a up to the first (in the direction of revolution according to arrow 24) reversing roller 15a.

According to FIG. 4, the traction-exerting component 13 is guided in the direction of revolution—according to arrow 24—from the driving wheel 17 via the additional reversing wheel 16 and second tensioning element 19b, then via the two reversing roller 15a, 15b, and subsequently via the first tensioning element 19a and back to the driving wheel 17, whereby the pulled strand 28 of the traction-exerting element 13 is consequently running from the reversing roller 15a, 15b via the first tensioning element 19a up to the driving wheel 17, whereas the returning drum 29 of the traction-exerting component 13 is running from the driving wheel 17 via the additional reversing wheel 16 and the second tensioning element 19b to the second—in the direction of revolution according to arrow 24—reversing roller 15b.

As briefly mentioned already above, the tensioning device 18 comprises at least the two tensioning elements 19a, 19b, in particular tensioning wheels, which are supported on the support bodies 27a and, respectively, 27b. The latter are separated from one another and oppose each other in the direction of rotation—according to arrow 24—of the traction-exerting component 13, and are adjustable versus the frame 10 and relative to one another. The support bodies 27a, 27b are realized in the form of the guide carriages 30a, 30b, and each adjustably guided via a guide device (not shown in detail) along the slot-like track 25 extending parallel to the transport plane 12 of the driving mechanism 11. Furthermore, said support bodies are coupled with each other in terms of movement via at least one setting element 31 having a variable length. According to the embodiment presently described, said setting element 31 is formed by a spring element with a variable length, particularly a tension spring, the ends of which are hinged on the guide carriages 30a, 30b, the latter opposing each other in the direction of the longitudinal expanse of the slotted-link track 25. Thus the two guide carriages 30a, 30b and the tensioning elements 19a, 19b supported on said guide carriages, are coupled with one another in terms of movement via the setting element 31, so that unavoidable changes in the length of the traction-imparting component 13 occurring during the operation of the driving mechanism 11 due to extension, wear and aging depending on the mechanical load or stress, as well as on the climatic and other conditions, can be compensated, and the peripheral force required for transporting the piece goods 4 with the driving mechanism 11 is transmitted from the driving wheel 17 to the traction-exerting component 13 substantially free of slip.

Since any change in the length of the traction-exerting component 13 is reflected in the form of an extension of the latter in most cases of application, it is now possible via the setting element 31 to reduce the spacing 32 between the guide carriages 30a, 30b, which are adjustable relative to one another, and thus the spacing between the tensioning elements 19a, 19b, because with a lengthening occurring in the traction-exerting component 13, the tensioning elements 19a, 19b are driven toward each other, and each of said tensioning elements 19a, 19b exerts a tensioning force directed at the traction-exerting component 13 in the tensioning direction as indicated by arrows 33. The tensioning forces directed against each other in a line of application and acting in a plane extending parallel to the transport plane 12, ensue from the spring force exerted by the setting element 31, and are rated in accordance with the weight of the piece goods 4 to be transported. It is noted at this point that the strand force is higher in the pulled strand 28 than in the returning strand 29, and higher than the tensioning force acting on the tensioning elements 19a, 19b in contact with the pulled strand 28, such latter force counteracting the former. The strand force in the returning strand 29 is lower than the tensioning force acting on the tensioning elements 19a, 19b contacting the returning drum 29, and counteracting said force.

The distance of adjustment 34 shown in FIG. 4 for the guide carriages 30a, 30b adjustably guided along the slotted link track 25, is limited by the stop elements 26a, 26b arranged spaced from each other in the longitudinal expanse of the slotted link track 25. On their sides facing away from each other, the guide carriage 30a, 30b each form a stop surface 35a and 35b, respectively. According to FIG. 3, the guide carriage 30b provided with the tensioning element 19b contacting the pulled strand 28, and according to FIG. 4, the guide carriage 30a provided with the tensioning element 19a contacting the pulled strand 28, are supported at least during the advancing movement of the traction-exerting component 13—in the direction of rotation according to arrow 24—with their support surfaces 35b and 35a, respectively, on the stop elements 26b and 26a, respectively, associated with said stop surfaces 35b and 35a, respectively, and are retained in their positions by the action of the force of the strand. Accordingly, under any operating condition of the driving mechanism 11 of the traction-exerting conveyor component 13, one of the tensioning elements 19a and 19b, i.e. according to FIG. 3 the tensioning element 19b, and according to FIG. 4 the tensioning element 19b is in contact with the relieved, returning strand 29, so that irrespectively of the direction of revolution according to arrow 24, the traction-exerting conveyor component 13 is adequately tensioned even if the tensioning forces are low. In addition, the traction-imparting component 13 is automatically tensioned via the setting element 31.

If, in FIG. 1, the charged piece goods 4 are to be transported from the charging or inlet side 36 in the direction of the opposite discharge or outlet side 37 along the transport line of the conveyor device 1 in the direction of transport according to arrow 3 via the driving mechanism 11, the direction of rotation indicated by the arrow is admitted to the driving wheel 17, and the traction-exerting component 13 is put into the direction of rotation indicated by arrow 24 shown in FIG. 3, whereby the pulled strand 28 guided around the second (viewed in the direction of rotation indicated by arrow 24) tensioning element 19b will then displace the guide carriages 30a, 30b along the slotted link track 25 in the direction of the stop element 26b until the guide carriage 30b will come into contact with the stop element 26b with its stop surface 35b. Due to the feed movement of the traction-exerting component 13 in the direction of revolution according to arrow 24, and the effect of the force in the pulled strand 28, the guide carriage 30b is retained in its position against the stop element 26b, whereas when the guide carriage 30a, with an extension of the traction-exerting component 13 via the setting element 31, is driven toward the guide carriage 30b that is retained in its position, the traction-exerting component 13 is tightened in the returning strand 29, and the peripheral force is transmitted free of slip from the driving wheel 17 to the traction-exerting component 13.

However, if the piece goods 4 are to be transported in the opposite direction of conveyance along the line of transportation of the conveyor device 1 indicated by arrow 3, the direction of rotation indicated by the arrow is admitted to the driving wheel 17, and the traction-exerting component 13 is put into the direction of revolution indicated by the arrow 24 in FIG. 4, whereby viewed in the direction of revolution indicated by arrow 24, the pulled strand 28 guided around the first tensioning element 19a will displace the guide carriages 30a, 30b along the slotted link track 25 in the direction of the stop element 26a until the stop surface 35a of the guide carriage 30a comes into contact with the stop element 26a. Due to the feed movement of the traction-exerting component 13 in the direction of rotation indicated by arrow 24, and the effect of the strand force in the pulled strand 28, the guide carriage 30a is retained in its position against the stop element 26a, whereas when the guide carriage 30b, with an extension of the traction-exerting component 13 via the setting element 31, is driven toward the guide carriage 30a that is kept in position, the traction-exerting component 13 is tightened in the returning strand 29, and the peripheral force is transmitted free of slip from the driving wheel 17 to the traction-exerting component 13.

In a preferred embodiment, the driving and tensioning wheels 17 and also the additional reversing wheel have identical radii or diameters, and the axial spacing 40 between the tensioning wheels parallel to the transport plane 12 is dimensioned smaller than the axial spacing 41 parallel to the transport plane 12 of the traction-exerting component 13 between the additional reversing wheel 16 and driving wheel 17. The additional reversing and driving wheels 16, 17, respectively, are arranged in a plane below the tensioning elements 19a, 19b, said plane extending parallel to the transport plane 12.

If the additional reversing wheel 16 is supported on a tensioning bearing 42 (shown only highly simplified in the figures) that is adjustable versus the frame 10 in the direction parallel to the tensioning direction—indicated by arrow 33—of the tensioning elements 19a, 19b, easy installation and dismantling of the traction-exerting component 13 with the tensioning device 18 installed therein are ensured. In this connection, the tensioning bearing 42 can be adjusted, for example via a setscrew not shown in detail, so that the tension of the traction-exerting component 13 can be preset as it is being installed, or its tension relieved when it is removed. The expert is familiar with such tensioning bearings 42, so that a detailed description is dispensed with in the present application.

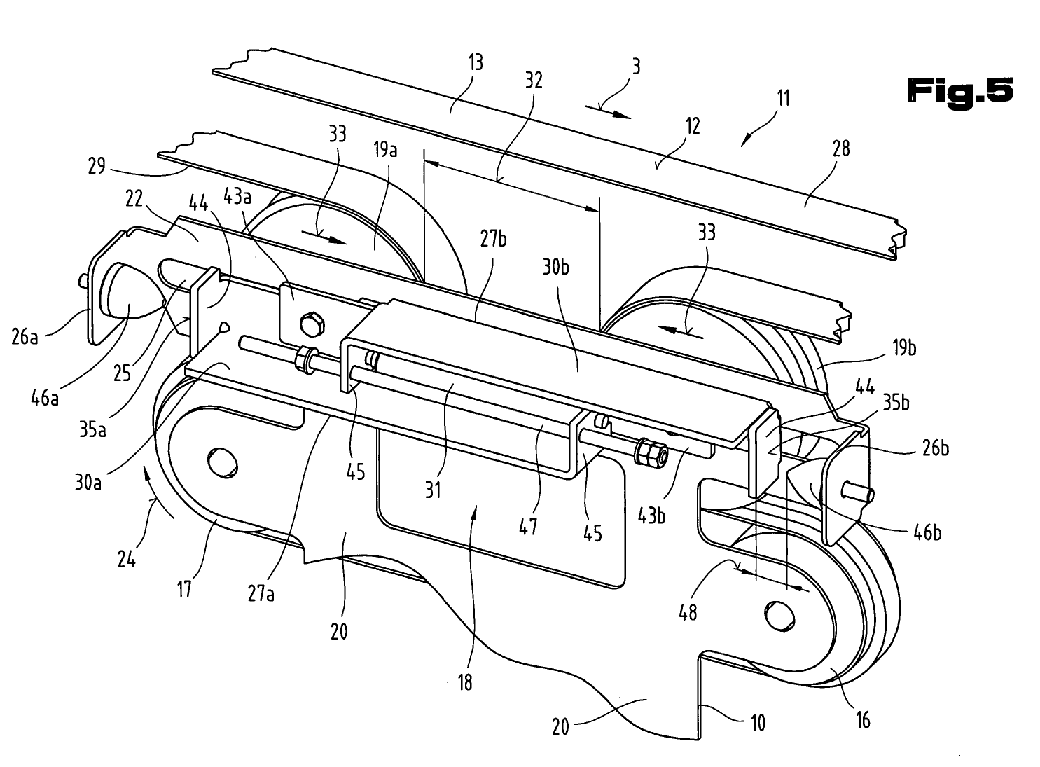

FIG. 5 shows a perspective, simplified view of a part area of a second embodiment of the driving mechanism 11 and traction-imparting component 13 as defined by the invention. The driving mechanism 11 for the traction-exerting component 13 comprises the frame 10 that is secured on the support frame 2 of the conveyor device 1; the pair of reversing wheels 15a, 15b (not shown), said reversing wheels being spaced from each other in the transport direction—indicated by arrow 3—and disposed adjacent to the transport plane 12; the additional reversing and driving wheels 16, 17 supported on the frame 10; the traction-exerting component 13; as well as the tensioning device 18 with the two tensioning elements 19a, 19b. Starting from the driving wheel 17, the traction-exerting component 13 is guided via the additional reversing wheel 16, if any; and one of the tensioning elements 19a, 19b, and via the reversing wheels 15a, 15b arranged adjacent to the transport plane 12 of the traction-exerting component 13; and subsequently via the other of the tensioning elements 19b, 19b back to the driving wheel, whereby the second—in the direction of rotation according to arrow 24—tensioning element 19b is in contact with the pulled strand 28, and the other first—in the direction of rotation according to arrow 24—tensioning element 19a is in contact with the returning strand 29.

The frame 10, particularly the connecting bridge 22, is provided with the slotted link track 25 in the form of a longitudinal guide, for example a longitudinal slot extending parallel to the transport plane 12 in the direction of the longitudinal expanse of the driving mechanism 12 of the traction-imparting component, and the support bodies 27a, 27b in the form of the guide carriages 30a, 30b are adjustably guided along said longitudinal slot. The support bodies 27a, 27b are each provided for said purpose with a supported guiding device (not shown) that is guided along the slotted link track 25. The tensioning element 19a, particularly the tensioning wheel, is supported via a sheet metal mounting plate 43a on the guide carriage 30a, and the tensioning element 19b, particularly the tensioning wheel via a sheet metal mounting plate 43b on the guide carriage 30b, particularly in a freely rotational manner.

The two guide carriages 30a, 30b are coupled with each other in terms of movement via at least one setting element 31 having a variable length. According to the present embodiment, the setting element 31 is formed by a gas pressure spring. However, said element may have the form of a cylindrical coil spring such as a pressure spring as well. The guide carriages 30a, 30b are each formed by a sectional angle having a preferably L-shaped cross section with the tabs 44, 45, which are bent off at the ends perpendicular to the movement of adjustment of the guide carriages 30a, 30b. On their sides facing away from each other, the guide carriages 30a, 30b are forming with their removed tabs 44 the stop surfaces 35a, 35b. The setting element 31, particularly the gas pressure spring, is clamped between the adjacent tabs 45 of the guide carriages 30a, 30b, which are arranged overlapping each other. Any lengthening of the traction-exerting component 13 occurring during the operation of the driving mechanism 11 due to expansion, wear or any other conditions, can be compensated via the setting element 31 having a variable length. As the lengthening of the traction-exerting component 13 increases, the spacing between the tabs 45 of the guide carriages 30a, 30b, the latter being adjustable against each other, is increased; the tensioning elements 19a, 19b are driven against one another; the spacing 32 between the tensioning elements 19a and 19b is reduced; and the tensioning forces of the tensioning elements 19a and 19b directed against each other and exerted onto the traction-exerting component 13 are raised so such an extent that the peripheral force transmitted from the driving wheel 17 to the traction-exerting component 13 is substantially transmitted free of slip.

As already described in detail above in connection with FIGS. 3 and 4, the guide carriage 30b provided with the tensioning element 19b and in contact with the pulled strand 28, is supported with its stop surface 35b on the stop element 26b, and retained there in its position. This is not shown in FIG. 5 in the interest of superior clarity.

On operating mode that is as protective as possible for the conveyor device 1 is feasible if the impact energy generated as the guide carriages 30a, 30b are impacting the stop elements 26a, 26b, respectively, is at least partly absorbed via the damping elements 46a 46b, respectively. Such damping elements 46a, 46b may be formed, for example by a buffer made of elastically yielding, rebounding plastic such as, for example an elastomer, or rubber and the like, or by shock absorbers filled with a compressible medium such as air, gas and the like; or by industrial shock absorbers filled with hydraulic oil. Such industrial shock absorbers permit, for example a constant delay. The piston rod is inserted in the shock absorber during the braking process. The hydraulic oil in front of the piston is displaced through throttle openings and received by an absorber.

According to another variation not shown herein, the damping elements 46a, 46b are arranged on the tabs 44 of the guide carriages 30a, 30b, said tabs being removed from each other and forming the stop surfaces 35a, 35b.

FIG. 5 shows, furthermore, that in addition to the tensioning elements 19a, 19b; the guide carriages 30a, 30b, and at least one setting element 31, the tensioning system 18 additionally comprises an installation accessory 47, particularly a threaded rod that simplifies handling when the traction-imparting conveyor component 13 is replaced. For removing the latter, the gas spring is compressed with the help of said accessory 47 by reducing the spacing between the tabs 45, so that the tensioning forces acting on the traction-exerting component 13 will be cancelled and the latter relieved.

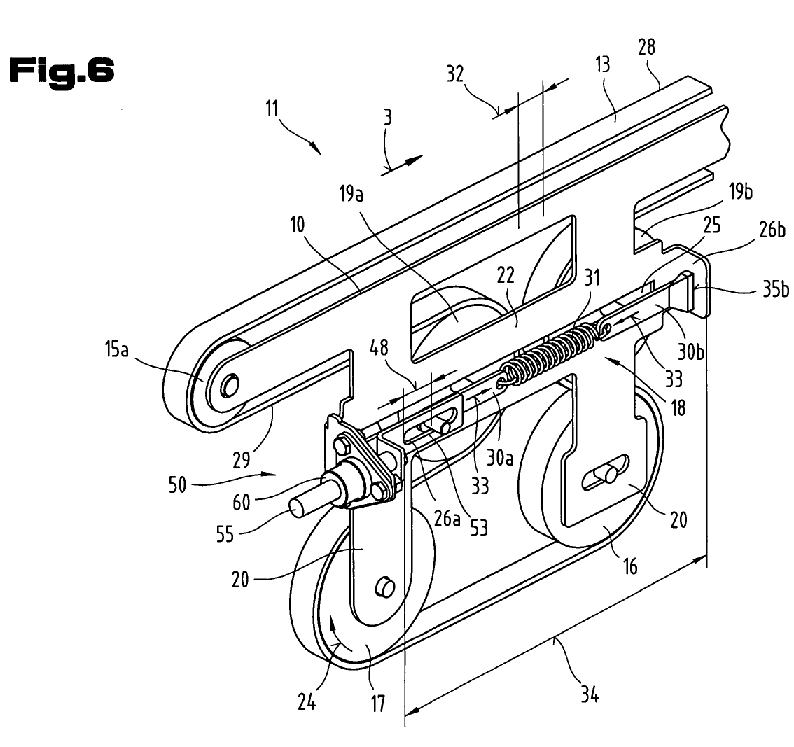

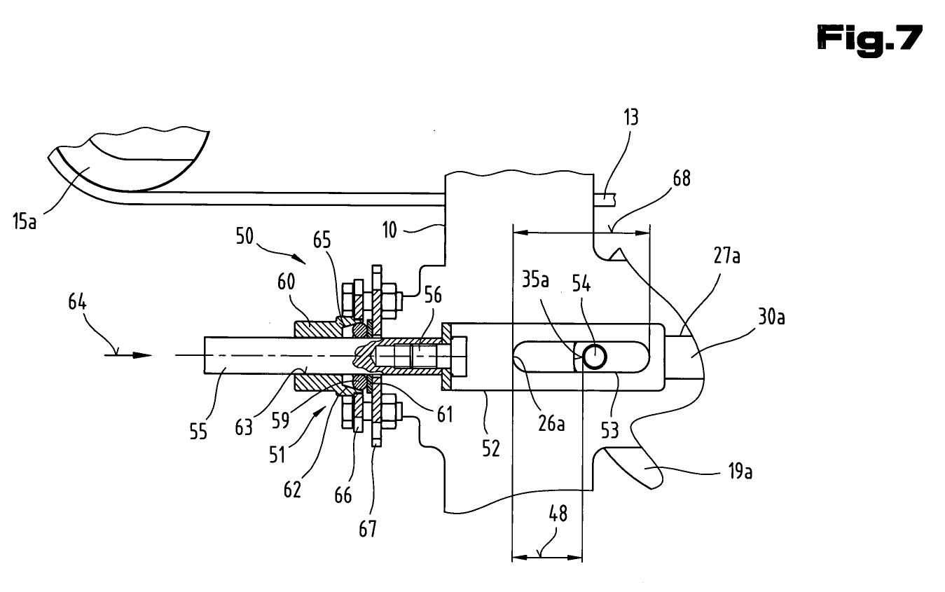

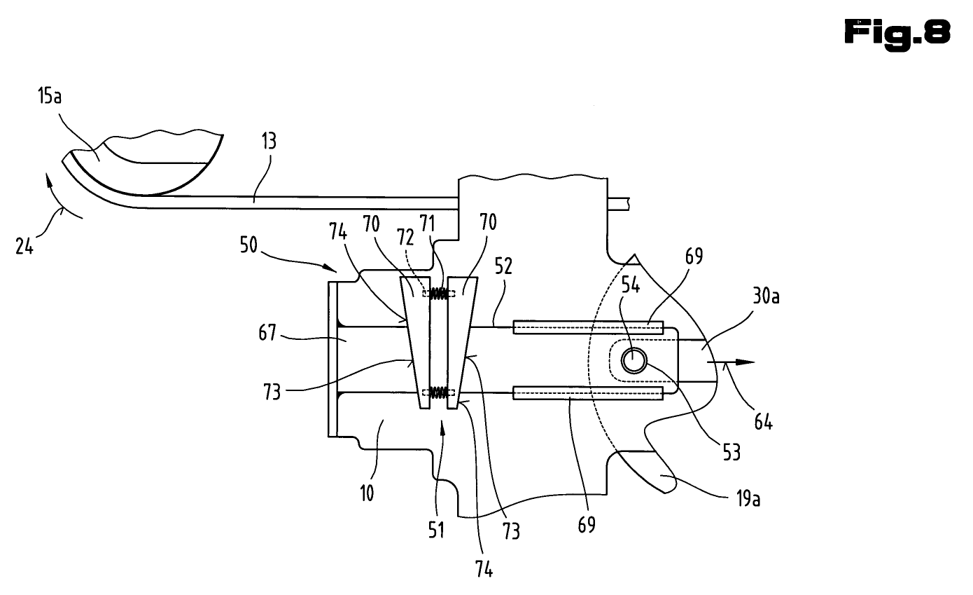

FIG. 6 shows a third variation of a part area of the driving mechanism 11, and FIG. 7 an enlarged cutout from FIG. 6. The driving mechanism 11 for the traction-imparting component comprises the frame 10; the pair of reversing wheels 15a and 15b, which are arranged spaced from each other in the transport direction indicated by arrow 3; the additional reversing wheel 16; the driving wheel 17; the traction-exerting component 13; as well as the tensioning device 18 described above, with the two tensioning elements 19a and 19b. The latter are rotationally supported on the support bodies 27a and 27b, or guide carriages 30a, 30b, which are separate components and adjustable against each other in the longitudinal direction of the slot 25. The guide carriages 30a, 30b are coupled with other in terms of moment via the at least one setting element 31.

Said design variation is excellently suited for conveyor systems 1 where frequent changes from the normal to the reverse mode of operation, i.e. changes of the direction of rotation according to arrow 24—or direction of transport—according to arrow 3—of the piece goods shown in FIG. 1, or significant changes in the weight of the conveyed goods and rate of conveyance of the piece goods 4 have to be expected.

As already described above, as the lengthening of the traction-exerting component 13 increases, the first tensioning element 19a in contact with the returning strand 29 according to the present figure, is driven in the direction of the second tensioning element 19b that is in contact with the pulled strand and kept in position there, as the guide carriage 30a is being driven in said direction as well. This causes the adjustment spacing 48 shown in the individual figures between the stop surface 35a and the stop element 26a to increase as well. This means that after the direction of revolution of the traction-exerting component 13 has been reversed, the guide carriage 30a has to travel a greater adjustment distance 48.

So as to keep said adjustment distance 48 as low and constant as possible even if the traction-exerting component 13 has been extended due to variations in the conveying rate and weight of the conveyed goods, aging and the like, provision is made according to the present design variation that at least the one of the stop elements 26a is readjustable in the direction of the respective guide carriage 30a via a readjusting device 50 comprising the tensioning device 18. Thus the stop element 26a can be driven in the direction of the opposite stop element 26b, and the adjustment distance 34 limited by the stop elements 26a, 26b can be shortened in this way.

The unilaterally acting, automatic readjustment device 50 comprises a locking device 51 and a preferably L-shaped coupling element 52 arranged between said locking device and the respective support body 27a or guide carriage 30a. Said support body 27a and the coupling element 52 comprise the guide elements 53, 54 engaging one another. The guide element 53 of the coupling element 52 is formed by a limited longitudinal slot extending parallel to the transport plane 12, and the guide element 43 of the support body by a preferably cylindrical guide attachment protruding into said longitudinal slot. With its end disposed removed from the support body 27a, the longitudinal slot in the coupling carriage 52 is forming the stop element 26a, whereas the opposite stop element 26b is disposed stationary on the frame 10. The stop surface 35a on the support body 27a is formed by the guide attachment. With its end facing away from the support body 27a, the coupling element 52 is connected with a push rod 55 comprising the locking device 51, and particularly screwed to said push rod via a connection element 56.

In addition to the cylindrical push rod 55, the locking device 51 comprises a locking element supported on said rod, particularly a clamping body 59; a rotation-symmetrical receiving body 60 disposed coaxially with the push rod 55; as well as a spring element 61. The receiving body 60 is provided with a recess 62 arranged in a lateral surface facing the support body 27a, and with a bearing bore 63 penetrated by the push rod 55. The recess 62 disposed coaxially with the push rod 55 is forming an engagement surface 65 conically tapering in the direction opposing the readjustment direction—indicated by arrow 64—of the push rod 55 or stop element 26a. In the present embodiment, the clamping body 59 is formed by clamping rollers accommodated in a cage not shown, and the clamping body or the clamping rollers with the cage are axially displaceably supported on the push rod 55 within the recess 62 in the receiving body 60. The receiving body 60 is preferably detachably connected with, particularly screwed to a flange 66 on a frame component 67 of the frame 10.

Via the spring element 61 arranged between the clamping body 59 and the frame component 67, the clamping body 59 is initially tensioned against the readjusting direction—indicated by arrow 64—against the conical engagement surface 65 in the re—ceiving body 60. Any adjusting movement of the push rod 55 directed against the readjusting direction—as indicated by arrow 64—of the stop element 26a is blocked in this way via the clamping body 59.

The longitudinal slot in the coupling element 52 has a guiding length 68 that is dimensioned in such a way that any lengthening of the traction-exerting component 13 depending on the weight of the piece goods to be transported will not trigger any readjustment of the stop element 26a. Only an extension of the traction-exerting component 13 to a greater extent that may be caused, for example by aging, will effect a readjustment of the stop element 26a, as described below

If a lengthening of the traction-imparting component 13 occurs in the course of the normal operation of the driving mechanism 11 for said traction-imparting component, the tensioning elements 19a, 19b are driven against each other via the setting element 31 to an extent such that the peripheral force is transmitted from the driving wheel 17 to the traction-exerting component free of slip. In the present embodiment, with the adjusting movement of the tensioning element 19a and guide carriage 30a, the guide attachment slidingly guided along the longitudinal slot is also driven in the direction of the end of the longitudinal slot facing the guide carriage 30a.

If, in this connection, the guide carriage 30a supporting the tensioning element 19a is adjusted to such an extent that the guiding length 68 is exceeded, the guide attachment will be in contact with the end of the longitudinal slot disposed adjacent to the guide carriage 30a, and with any further adjusting movement of the guide carriage 30a in the direction of the opposite guide carriage 30b, the coupling element 52 and also the push rod 55 will be displaced in the direction of readjustment indicated by arrow 64. In the course of adjustment of the push rod 55 in the readjusting direction indicated by arrow 64, the initial tension of the spring element 61 exerted on the clamping body 59 supported on the conical engagement surface 65 will be cancelled, and the push rod 55 will be released from the receiving body 60.

However, since the stop element 26a formed by the coupling element 52 is driven in the direction of readjustment—indicated by arrow 64—toward the guide carriage 30a as well, the adjustment distance 48 between the stop surface 35a formed by the guide attachment, and the stop element 26a is shortened as well, so that in the reverse operation, i.e. after the direction of revolution indicated by arrow 24 has been reversed, the guide carriage 30a supporting the tensioning element 19a contacting the pulled strand 28 has to be adjusted only by the reduced adjustment distance 48 up to the stop element 26a.

Even if the guide extension impacts the stop element 26a at a high adjustment speed, any adjustment movement of the push rod 55 and also of the stop element 26a directed against the direction of readjustment of the stop element 26a—as indicated by arrow 64—will be blocked by the locking device 51. It is possible in this way to avoid an unnecessarily long adjustment distance of the movement of the guide carriages 30a, 30b with the tensioning elements 19a, 19b when the direction of revolution—indicated by arrow 24—of the traction-imparting component 13 is changed.

According to another embodiment of the clamping body 59 not shown, the latter is formed by a rotation-symmetrical clamping ring that is disposed coaxially with the push rod 55 and axially displaceably supported on said rod. Said clamping ring forms a conical engagement surface complementing the engagement surface 65 in the receiving body 60.

The jointly described FIGS. 8 to 10 show another design variation of the readjustment device 50 by a highly simplified representation. Said device is arranged between the frame 10 of the driving mechanism 11 and one of the guide carriages 30a, 30b, and comprises the locking device 51; the coupling element 52 arranged between said locking device and the respective guide carriage 30a; as well as a longitudinal guide displaceably supporting the coupling element 52. The longitudinal guide has two vertical and lateral guide tracks 69 arranged on both sides of the coupling element 52, via which the latter is supported and guided substantially free of play on the frame 10. Such vertical and lateral guide tracks 69 may be formed by a slide or roller guide such as, for example a dovetail and prism guide, or a circulating ball guide etc. The coupling element 52 is designed in the form of a prismatic carriage and, like the guide carriage 30a, has the guide elements 53, 54 engaging each other. The guide element 54 on the guide carriage 30a is formed by a cylindrical guide attachment, and the guide element 53 on the coupling carriage by a cylindrical bore.

The readjusting device 50 comprises the locking device 51 with at least two locking elements, particularly the clamping wedges 70, which are arranged spaced from each other in the direction of readjustment indicated by arrow 64, and at least one, preferably two initially tensioned spring elements 71 disposed between the clamping wedges 70. The clamping wedges are adjustably supported on the two guide bolts 72 expending parallel to the longitudinal expanse of the coupling element 52, and are adjustable relative to each other and vis-à-vis the frame 10. The spring elements 71, particularly pressure springs, surround the guide bolts 72.

The frame component 67 of the frame 10, on its side facing the guide carriage 30a, and the coupling element 52, on its side facing away from the guide carriage 30a, are provided with the engagement surfaces 73. The latter extend against each other from the top downwards in the direction of gravity, and are spaced from each other in the direction of readjustment indicated by arrow 64. The clamping wedges 70, which are initially tensioned by the spring elements 71 in opposite directions, are arranged between said engagement surfaces 73. With their engagement surfaces 74, which are extending inclined against each other, facing away from each other and facing the frame component 67 as well as the coupling element, said clamping wedges are supported on the engagement surfaces 73 of the frame component 67 and the coupling element 52. The engagement surfaces 74 of the clamping wedges 70 are adapted to complement the engagement surfaces 73 of the frame component 67 and the coupling element 52.

Such a design of the readjustment device 50 is employed in conveyor devices or driving mechanisms 11 with a short transport distance, e.g. in the range of 3 m and 6 m, where it can be expected that any lengthening of the traction-imparting conveyor component 13 will occur only to a limited extent, or when piece goods 4 with highly varying weights have to be conveyed.

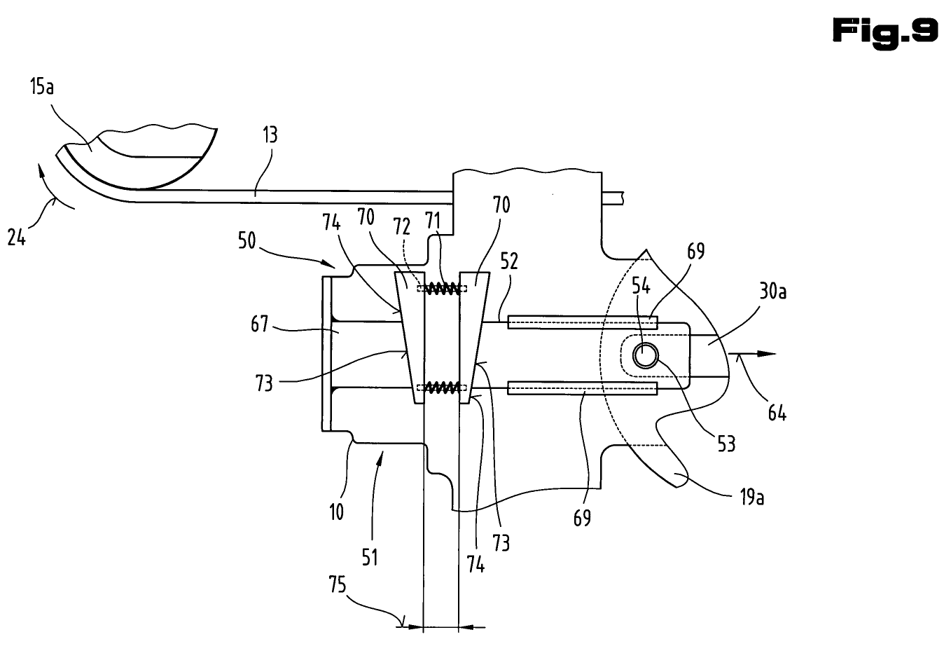

FIG. 8 shows the readjusting device 50 in its starting position, with the traction-imparting component 13 in the unloaded condition, whereas FIG. 9 shows the readjusting device 50 in a first actuated position, in which the guide carriage 30a is automatically readjusted in the direction of readjustment—indicated by arrow 64—due to the lengthening of the traction-imparting component 13, such lengthening depending on the weight (operating load) of the piece goods 4 to be transported. The guide carriage 30b (as shown in FIG. 6) is supported on the stop element 26b (as shown in FIG. 6) because the tensioning element 19b (as shown in FIG. 6) is in contact with the pulled strand. The tensioning element 19a is in contact with the returning strand, and the tension in the traction-imparting component 13 is generated via said tensioning element. When the direction of revolution is reversed as indicated by arrow 24, the tensioning element 19a is in contact with the pulled strand, and the tension in the traction-imparting component 13 is generated via the tensioning element 19b. The traction-imparting component 13 is driven in this connection via the driving wheel 17 as shown, e.g. in FIG. 6.

As the lengthening of the traction-exerting component 13 is increasing, the guide carriage 30a migrates from the position shown in FIG. 8, into the position shown in FIG. 9. In this process, the coupling element 52 is driven via the guide element 54 in the direction of readjustment—indicated by arrow 64—toward the guide carriage 30b disposed opposite the guide carriage 30a, and away from the frame component 67, so that the two clamping wedges 70 are driven apart to a limited extent by the action of the spring elements 71.

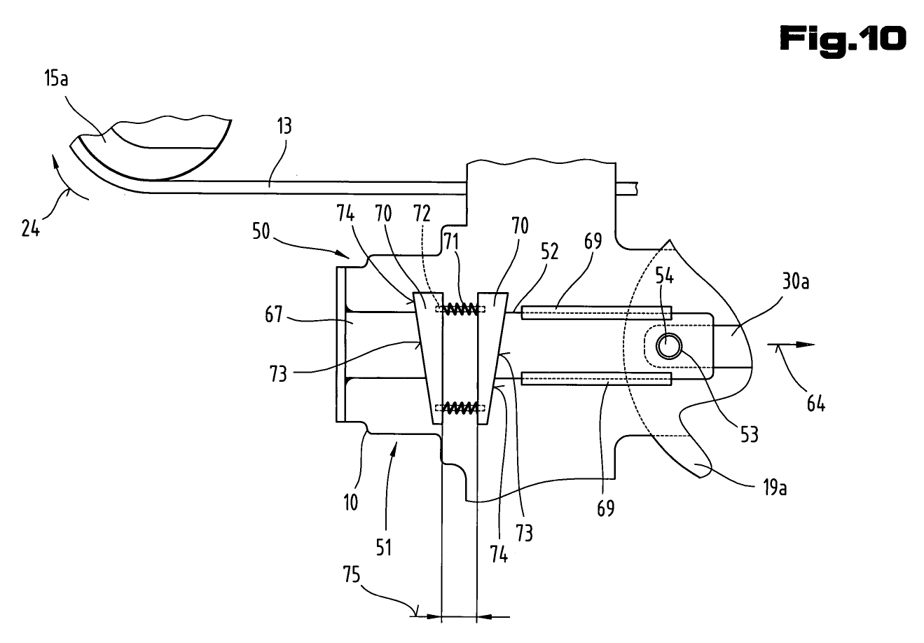

If any additional lengthening or extension of the traction-imparting component 13 occurs due to aging, the readjusting device 50 is driven into a second actuation position as shown in FIG. 10, whereby the coupling element 52 is driven away from the frame component 67 to such an extent that the clamping wedges 70 are adjusted beyond the limited, maximum measure 75 shown in FIG. 9, and the two clamping wedges 70 are driven downwards in the direction in which the gravity is acting.

Therefore, under all operating conditions of the conveyor device 1, the clamping wedges 70 are reliably initially tensioned with their engagement surfaces 74 against the engagement surfaces 73 of the frame component 67 and coupling element 52.

The present embodiment has the additional advantage that when the direction of revolution is reversed, the spring elements 71 start to act as damping elements as well, and the kinetic energy generated by the slight, sudden adjusting movement of the coupling element 52 or guide carriages 30a, 30b is absorbed via the spring elements 71.

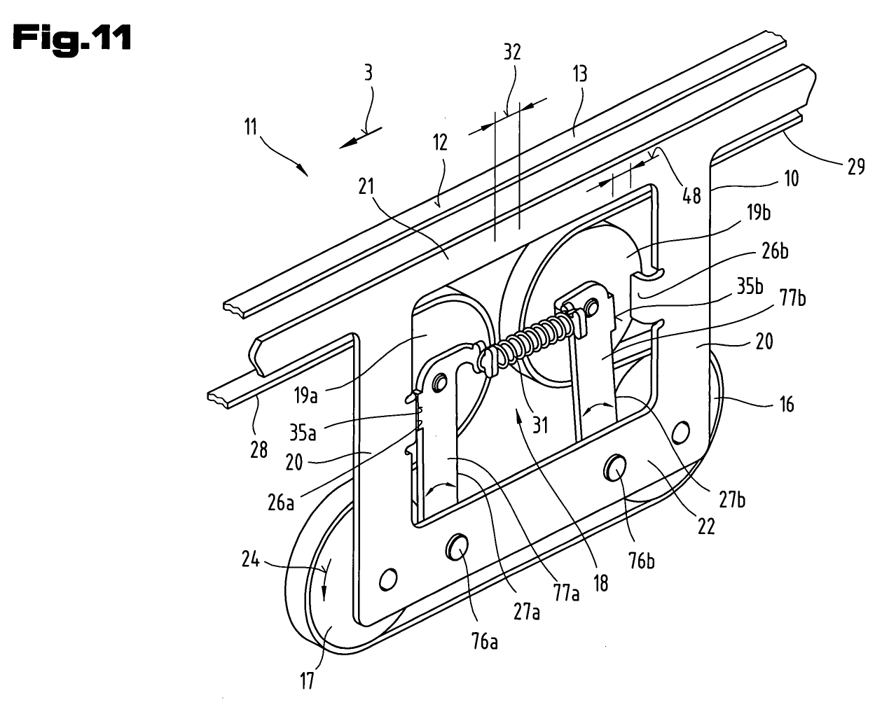

FIG. 11 shows a perspective view of a fourth design variation of the driving mechanism 11 for the traction-exerting component of the conveyor device shown in FIG. 1. The driving mechanism 11 comprises the frame 10 secured on the support frame 2 of the conveyor device 1; the reversing wheels 15a, 15b (not shown), which are supported on said frame and arranged spaced from each other in the transport direction indicated by arrow 3, and disposed adjacent to the transport plane 12; the additional reversing wheel 16 and driving wheel 17 rotationally supported on the frame 10; the traction-exerting component 13; as well as the tensioning device 18. Between the two reversing wheels 15a, 15b, the frame 10 comprises the two support legs 20 arranged in the longitudinal expanse of the driving mechanism 11, said support legs being arranged spaced from each other and aligned approximately perpendicular to the plane of transport 12; the support arm 21 connecting the support legs 20 with each other and extending approximately over the entire length of the driving mechanism 11; as well as the connecting bridge 22 extending between the support legs 20 substantially parallel to the transport plane 12.

The tensioning device 18 is comprised of the two support bodies 27a, 27b, which are arranged one after the other in the direction of transport indicated by arrow 24, and adjustable relative to one another. According to the present embodiment, said support bodies are formed by the rocker levers 77a, 77b, which are pivot-mounted on the axles 76a, 76b on the frame 10, particularly on the connecting bridge 22, extending perpendicular to the longitudinal expanse of the driving mechanism 11. The rocker levers 77a, 77b are coupled with each other in terms of movement via at least one setting element 31, particularly a tension spring having a variable length, and are each provided with a stop surface 35a, 36b, respectively, on their sides facing away from each other. A tensioning element 19a, 19b is freely rotationally supported on each of the free ends of the rocker levers 77a, 77b.

On their sides facing each other, the vertically rising, parallel support legs 20 are each provided with a stop element 26a and 26b, respectively, the latter being bent off from said sides. The rocker levers 77a, 77b of the tensioning device 18 are adjustable, particularly swiveling in relation to each other and arranged spaced from one another between the two stop elements 26a, 26b in their direction of adjustment.

As shown in the present figure, the rocker lever 77a provided with the tensioning element 19a in contact with the pulled strand 28 of the traction-exerting component 13, is supported with its stop surface 35a on the stationary stop element 26a, and, with no change in the direction of revolution indicated by arrow 24, the tensioning element 19a is retained in its set position by means of the pulled strand 28. The tensioning element 19b supported on the rocker lever 77b and in contact with the returning strand 29 of the traction-imparting component 13, is driven via the setting element 31 in the direction of the tensioning element 19a that is retained in its set position, as the lengthening of the traction-imparting component 13 increases, and the latter is automatically retightened. The significant advantage in this connection is that the required tension in the traction-imparting component 13 is automatically maintained via the tensioning element 19b—the latter being acted upon by the force of the setting element 31—while the driving mechanism 11 is operating, even if the traction-imparting component 13 has been extended.

After the direction of revolution—indicated by arrow 24—of the traction-imparting component 13 has been reversed, the tensioning element 19b is in contact with the pulled strand 28; the stop surface 35b of the rocker lever 76b is supported on the stop element 26b; and with no change in the direction of revolution according to arrow 24, the tensioning element 19b is retained in its set position by means of the pulled strand 28, whereas the tensioning element 19a is driven via the setting element 31 in the direction of the opposite tensioning element 19b as the lengthening of the traction-imparting component 13 increases.

As shown in the preceding individual figures, the adjustment distance 48 ensues in depending upon the length of the conveyor system 1 or traction-exerting component 13, because it is known that particularly long traction-exerting components 13 are subject to a high degree of expansion or lengthening, and shorter traction-imparting components only to minor lengthening. Furthermore, the change from normal to reverse operation also causes an undesirable rise in the kinetic energy of the guide carriages 30a, 30b during their adjustment as their adjustment distance increases, so that the impact of the guide carriage 30a, 30b against the stop element 25a, 26b in connected with high mechanical stress of the frame 10 and the tensioning system 18, on the one hand, and the traction-imparting component 13 is put into undesirable vibration on the other.

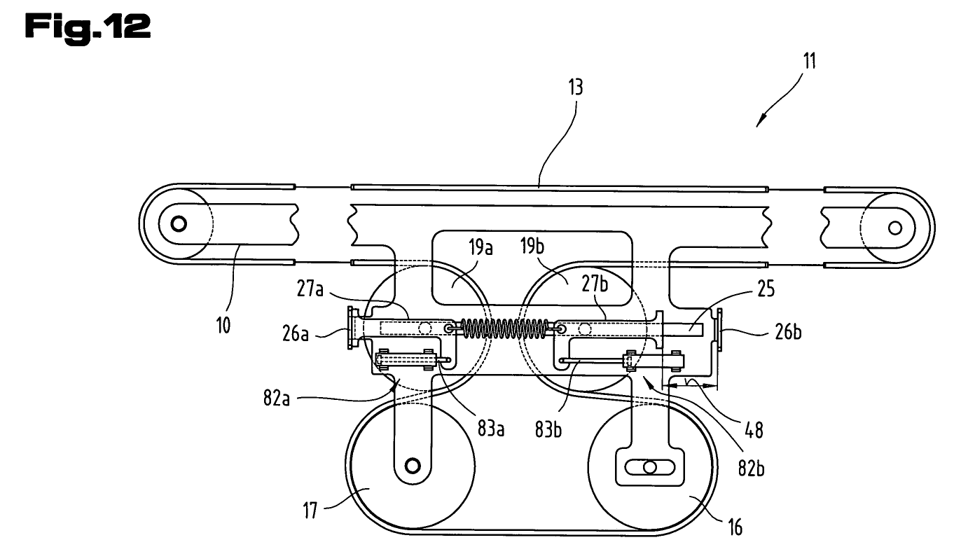

Now, in order to counteract said drawback, provision is made as shown in FIG. 12 for an adjustment speed limiter 82a, 82b in the form of a cylinder-piston arrangement, which is arranged between the support bodies 27a, 27b, and the guide carriages 30a, 30b, respectively. The support bodies 27a, 27b are synchronously adjusted in this connection by the adjustment distance 48 at an adjustable and constant rate of adjustment in the direction of the stop element 26b. Such adjustment speed limiters 84a, 84b are known in the prior art and preferably formed by an industrial shock absorber with integrated throttle openings of the type described above. The maximally permissible rate of adjustment of the supper bodies 27a, 27b can be set with such speed limiters. Each cylinder-piston assembly is hinged on the support body 27a, 27b via a piston rod 83a, 83b, respectively. On the other hand, the cylinder-piston assembly can be filled also with a compressible medium such as air or gas contained sealed in such an assembly.

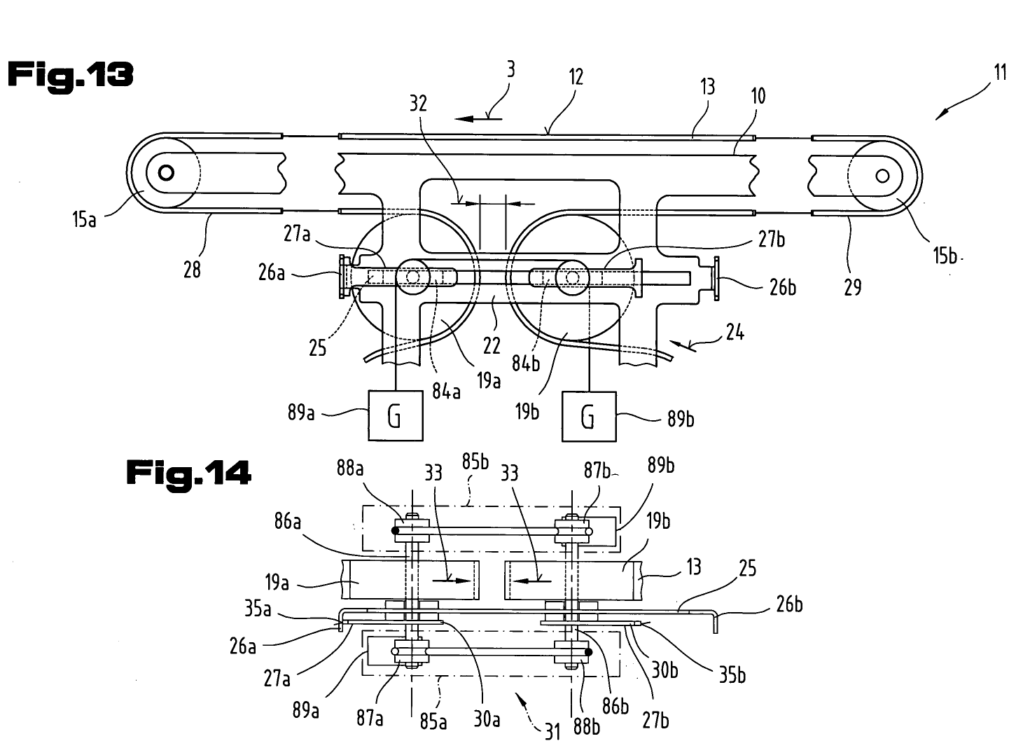

In the jointly described FIGS. 13 and 14, the driving mechanism 11 for the traction-imparting component as defined by the invention is shown by different views with another design variation of the tensioning device 18. The structure of the driving mechanism 11 has already been described above in detail and is applicable to the present figures as well. The tensioning device 18 comprises the support bodies 27a and 27b, which are arranged one after the other in the direction of revolution—indicated by arrow 24—of the traction-exerting component 13, and are adjustable relative to each other; and the tensioning elements 19a and 19b, respectively, which are supported on said support bodies. The prism-like support bodies 27a and 27b are each supported guided via the guide device 84a, 84b along the slot-like slotted link track 25 extending parallel to the transport plane 12 of the driving mechanism 11 driving the traction-imparting component. According to the direction of revolution indicated by arrow 24, the traction-imparting component 13 is guided with its pulled strand 28 around the tensioning element 19a, and with its returning strand 29 around the tensioning element 19b, the reversing wheels 15a, 15b, as well as around the additional reversing and driving wheels 16 and, respectively, 17 not shown. The two tensioning elements 19a, 19b are acted upon by tensioning forces directed against each other as indicated by the arrows 33, and are arranged with a spacing from each other that is adjustable via the setting element 31.

The setting element 31 is formed, for example by the two weight-loaded cable lines 85a and 85b. FIG. 14 shows that the guide carriage 30a is provided with an axle 86a aligned perpendicular to the longitudinal expanse of the driving mechanism 11. Said axle vertically penetrates the slotted link track 25 in the frame 10. A reversing roller 87a for guiding the first cable line 85a is freely rotationally supported on the first axle section projecting in the direction of the guide carriage 30a, and the first tensioning element 19a and a fastening element 88a for securing the free end of the second cable line 85b are arranged on the second axle section protruding from the slotted link track in the opposite direction. Furthermore, the guide carriage 30b is provided with an axle 86b aligned perpendicular to the longitudinal expanse of the driving mechanism 11, said axle vertically penetrating the slotted link track 25 in the frame 10. Furthermore, a fastening element 88b for securing the free end of the first cable line 85a is arranged on the first axle section protruding in the direction of the guide carriage 30b, and the second tensioning element 19b and a reversing roller 87b for guiding the second cable line 85b, are freely rotationally supported on the second axle section protruding from the slotted link track 25 in the opposite direction.

The first cable line 85a comprises a cable, which is rigidly connected with its free, first end with the axle 86b of the guide carriage 30b via the fastening element 88b; guided via the reversing roller 87a rotationally supported on the axle 86a of the guide carriage 30a, and loaded on its opposite free, second end with a weight 89a. The second cable line 85b is arranged mirror-inverted versus the first cable line 85a. Accordingly, the cable is fixed with its free first end via the fastening element 88a arranged on the axle 86a of the first guide carriage 30a, guided via the reversing roller 87b rotationally supported on the axle 86b of the second guide carriage 30b, and loaded with the weight 89b at its opposite free, second end.

Thus the two separate guide carriages 30a and 30b are coupled with each other in terms of movement via the weight-loaded cable lines 85a and 85b forming the setting element 31, and the guide carriage 30a on which the tensioning element 19a contacting the pulled strand 28 is arranged, is supported with its stop surface 35a on the stop element 26a, and retained in said position until the direction of revolution indicated by arrow 24 is reversed.

In another embodiment not shown herein, the setting element 31 is formed by only one weight-loaded cable line. In said embodiment, the tensioning device 18 is substantially structured as shown in FIG. 11, with the difference that the spring is replaced by a weight-loaded cable line, and a reversing roller is additionally rotationally supported on each of the free ends of the rocker levers 77a, 77b. The cable is secured with a first end on the frame 10, particularly on the right support leg 20, then first guided around the first reversing roller supported on the left rocker lever 77a, subsequently around the second reversing roller supported on the right rocker lever 77b, and thereafter around an additional reversing roller rotationally supported on the frame 10, particularly on the left support leg 20. A weight is secured on the free second end of the cable, or the latter is pulled at its free end with a tensioning force generated by a spring or the like.

In the FIGS. 3 to 13 described above, the peripheral force is transmitted by friction grip from the driving wheel 16 to the traction-imparting component 13, particularly a flat belt and the like. Without vacating the idea of the invention, it is possible also according to the embodiments shown in FIGS. 3 to 13 to employ as the endless traction-imparting component 13 a toothed belt or a chain, whereby the peripheral force is transmitted from the driving wheel 16 to the traction-imparting component 13 via a form-locked connection. With the tensioning systems 18 described above, it is now possible also with such driving mechanisms 11 driving the traction-imparting component to maintain the tension in the latter as described above, and to avoid vibrations in said traction-exerting component.

Finally, it is also pointed out that the tensioning elements 19a, 19b may be formed also by a guide component arranged on the support bodies 27a, 27b, for an approximately curved, particularly semicircular reversal of the traction-exerting component 13 guided along such a means. Likewise, at least one of the reversing wheels 15a, 15b, or the additional reversing wheel 16 may be formed by a reversing component with a curved guide coating for the traction-exerting component 13 guided thereon. Furthermore, it is possible that in addition to the driving wheel 17, at least one of the tensioning elements 19a, 19b, particularly tensioning wheels, and/or the additional reversing wheel 16 are coupled with the drive 23 and motor-driven. On the other hand, at least one of the two reversing wheels 15a, 15b may be driven, whereas the driving wheel 17 is replaced by an additional reversing wheel arranged in a plane parallel to the additional reversing wheel 16. The tensioning wheels, the reversing wheels 15a and 15b, and the additional reversing wheel 16 and driving wheel 17 are arranged with their axles extending parallel to each other.

FIGS. 5 to 13 show another embodiment of the driving mechanism 11 that may be independent per se, whereby identical reference numerals are again used for identical components as in the preceding figures.

Finally, it is pointed out for the sake of good order that in the interest of superior understanding of the structure of the driving mechanism 11 for the traction-imparting conveyor component, the latter or its components are partly shown untrue to scale and/or enlarged and/or reduced.

Most important of all, the embodiments shown in the individual FIGS. 1, 2, 3, 4; 5; 6, 7; 8, 9, 10; 11; 12, 13 and 14 may constitute the object of independent solutions as defined by the invention. The relevant problems and solutions according to the invention are disclosed in the detailed descriptions of said figures.

### List of Reference Numbers

1 Conveyor device 21 Support arm
2 Support frame 22 Connecting bridge
3 Conveying direction 23 Drive
4 Piece goods 24 Direction of revolution
5 Side part 25 Slotted link track
6 Crosstie 26a Stop element
7 Lateral guide rail 26b Stop element
8 Support foot 27a Support body
9 Set-up surface 27b Support body
10 Frame 28 Pulled strand
11 Driving mechanism for the 29 Returning strand tractive component 30a Guide carriage
12 Transport plane 30b Guide carriage
13 Tractive component 31 Setting element
14 Driving station 32 Spacing/distance
15a Reversing wheel 33 Tensioning direction
15b Reversing wheel 34 Adjustment distance
16 Reversing wheel 35a Stop surface
17 Driving wheel 35b Stop surface
18 Tensioning device 36 Inlet side
19a Tensioning element 37 Outlet side
19b Tensioning element 40 Axial spacing
20 Support leg 41 Axial spacing
42 Tensioning bearing 68 Guide length
43a Mounting plate 69 Vertical and lateral guide track
43b Mounting plate 70 Clamping wedge
44 Tab 71 Spring element
45 Tab 72 Guide bolt
46a Damping element 73 Engagement surface
46b Damping element 74 Engagement surface
47 Installation/removal accessory 75 Measure
48 Adjustment spacing 76a Axle
50 Readjusting device 76b Axle
51 Locking device 77a Rocker lever
52 Coupling element 77b Rocker lever
53 Guide element 82a Adjustment speed limiter
54 Guide element 82b Adjustment speed limiter
55 Push rod 83a Piston rod
56 Connection element 83b Piston rod
59 Clamping body 84a Guide device
60 Receiving body 84b Guide device
61 Spring element 85a Cable line
62 Recess 85b Cable line
63 Bearing bore 86a Axle
64 Readjustment direction 86b Axle
65 Engagement surface 87a Reversing roller
66 Flange 87b Reversing roller
67 Frame component 88a Fastening element
88b Fastening element
89a Weight
89b Weight

1. A driving mechanism for the traction-exerting component particularly of a conveyor device, comprising at least one reversing wheel and at least one driving wheel supported thereon; an endlessly revolving, flexible traction-exerting component having a pulled strand and a returning strand reversible with respect to the direction of revolution and guided around the reversing and driving wheels; a tensioning device; as well as at least one setting element, said tensioning device comprising support bodies arranged one behind the other in the direction of revolution of the traction-exerting component, and having tensioning elements adjustable relative to each other and arranged on said support bodies, whereby tensioning forces are admissible to said tensioning elements and the traction-exerting component is guided with its pulled strand around one of the tensioning elements, and with its returning strand around the other tensioning element, as well as around the reversing and the driving wheels and/or at least one additional reversing wheel supported on the frame, wherein the support bodies are coupled to each other in terms of movement.

2. The driving mechanism for the traction-exerting component according to claim 1, wherein on their sides facing away from each other, the support bodies each form a stop surface, and with the tensioning element in contact with the pulled strand, the support body is supported on a stop element and retained there in position.

3. The driving mechanism for the traction-exerting component according to claim 1, wherein the tensioning elements are arranged with a spacing from each other, whereby the spacing is adjustable to a limited extent via at least one setting device.

4. The driving mechanism for the traction-exerting component according to claim 1, wherein the support bodies serve as guide carriers and are separated from each other, and the tensioning elements are adjustably guided via the support bodies along a slotted link track extending on the frame over at least a part of the length of the driving mechanism for the traction-exerting component.

5. The driving mechanism for the traction-exerting component according to claim 1, wherein the support bodies are formed by rocker levers pivot-mounted on the frame for pivoting around axles extending perpendicular to the longitudinal expanse of the driving mechanism for the traction-exerting component.

6. The driving mechanism for the traction-exerting component according to claim 1, wherein the tensioning elements each are formed by at least one tensioning wheel rotationally supported on the support bodies.

7. The driving mechanism for the traction-exerting component according to claim 1, wherein the tensioning elements each are formed by at least one guide component arranged on the support bodies, and have an approximately curved, particularly semicircular reversing means for the traction-exerting component guided thereon.

8. The driving mechanism for the traction-exerting component according to claim 7, wherein each guide component with the reversing means is formed by the support body.

9. The driving mechanism for the traction-exerting component according to claim 2, wherein the adjustment distance of the support bodies is limited by two stop elements arranged spaced from each other, whereby the stop elements are arranged stationarily on the frame and the support bodies are adjustably supported on the frame between the stop elements.

10. The driving mechanism for the traction-exerting component according to claim 2, wherein the adjustment distance of the support bodies is limited by two stop elements arranged spaced from each other in the direction of adjustment of said support bodies; and at least one of the stop elements is adjustable in the direction of the respective support body via a readjusting device arranged between the support body and the frame, whereby the support bodies are adjustably arranged on the frame between the stop elements.

11. The driving mechanism for the traction-exerting component according to claim 10, wherein the readjusting device comprises a locking device with at least one locking element, whereby the latter blocks any adjusting movement of the stop element directed against the direction of readjustment of the stop element.

12. The driving mechanism for the traction-exerting component according to claim 10, wherein the readjusting device comprises a coupling device arranged between the locking device and the respective support body; and the coupling element and the respective support body have guide elements engaging one another.

13. The driving mechanism for the traction-exerting component according to claim 12, wherein the guide element of the coupling element is formed by a longitudinal slot, and the guide element of the support body by a guide attachment protruding into the longitudinal slot.

14. The driving mechanism for the traction-exerting component according to claim 12, wherein with its end facing away from the support body, the coupling element is connected with a push rod, the latter comprising the locking device and being adjustable versus the frame exclusively in the tensioning direction of the tensioning element disposed adjacent to the readjusting device.

15. The driving mechanism for the traction-exerting component according to claim 11, wherein in addition to the push rod and at least one locking element, particularly clamping body supported on said push rod, the locking device comprises a rotation-symmetrical receiving body disposed coaxially with the push rod and having a bearing bore penetrated by the push rod, and a recess disposed coaxially with the push road and having an engagement surface conically tapering in the direction opposing the readjustment direction of the stop element; as well as at least one spring element, whereby at least one locking device is initially tensioned via the spring element against the conical engagement surface and arranged between the frame and the receiving body, and the latter is secured on the frame.

16. The driving mechanism for the traction-exerting component according to claim 15, wherein the clamping body is formed by a clamping ring disposed coaxially with the push rod and having a conical engagement surface complementing the engagement surface of the receiving body, or formed by clamping rollers accommodated in a cage.

17. The driving mechanism for the traction-exerting component according to claim 12, wherein the coupling element comprises the stop element, the latter being adjustable in the same sense as the support body.

18. The driving mechanism for the traction-exerting component according to claim 10, wherein the stop element is formed by an end of the longitudinal slot in the coupling element, said end being removed from the support body.

19. The driving mechanism for the traction-exerting component according to claim 11, wherein the locking device comprises at least two locking elements, particularly clamping wedges arranged spaced from each other in the readjustment direction of the stop element, and at least one spring element initially tensioned between the locking elements, whereby the frame and the respective support body are provided with engagement surfaces facing each other and extending inclined against one another; the locking elements are provided with engagement surfaces complementing the engagement surfaces of said frame and support body; and the locking elements are initially tensioned via the spring element against the frame and respective support body in directions opposing each other.

20. The driving mechanism for the traction-exerting component according to claim 1, wherein the setting element is formed by a spring element, particularly a tension spring, pressure spring or gas spring having a variable length, or by a weight-loaded cable line.

21. The driving mechanism for the traction-exerting component according to claim 2, wherein the stop elements each are provided with a damping element such as a rubber buffer or fluid buffer.

22. The driving mechanism for the traction-exerting component according to claim 1, wherein on their sides facing away from each other, the support bodies each are provided with a damping element such as a rubber buffer or fluid damper, the latter forming stop surfaces.

23. The driving mechanism for the traction-exerting component according to claim 1, wherein at least one adjustment speed limiter, particularly a fluid cylinder-piston arrangement is arranged between the frame and the respective support body.

24. The driving mechanism for the traction-exerting component according to claim 1, wherein the setting element is at the same time forming a damping element.

25. The driving mechanism for the traction-exerting component according to claim 1, wherein starting from the driving wheel, the traction-exerting component is guided via the additional reversing wheel, if any, and one of the tensioning elements; the two reversing wheels arranged adjacent to the transport plane of the traction-exerting component; and subsequently back to the driving wheel via the other tensioning element, whereby one of the tensioning elements is in contact with the pulled strand, and the other tensioning element with the returning strand.

26. The driving mechanism for the traction-exerting component according to claim 1, wherein the two support bodies or tensioning elements of the tensioning device are arranged in a plane below the pulled strand and substantially disposed next to each other in a plane extending parallel to the transport plane of the traction-exerting component, as well as arranged between the reversing wheels for the strand guided around the latter.

27. The driving mechanism for the traction-exerting component according to claim 1, wherein the driving wheel and the first tensioning element, and the additional reversing wheel and the second tensioning element are arranged one on top of the other in sets of pairs; and/or the looping angle of the reversing and driving wheels as well as of the tensioning elements through the traction-exerting component amounts to about 180° in each case.

28. The driving mechanism for the traction-exerting component according to claim 1, wherein the radii of the tensioning elements and additional reversing and driving wheels are identical and/or that the axial spacing between the tensioning elements, particularly the tensioning wheels, such parallel spacing extending parallel to the transport plane of the traction-exerting component, is dimensioned smaller than the axial spacing between the additional reversing and driving wheels, such axial parallel spacing extending parallel to the transport plane of the traction-exerting component.

29. The driving mechanism for the traction-exerting component according to claim 1, wherein the additional reversing wheel is supported on a tensioning bearing on the frame, said tensioning bearing being adjustable versus the tensioning element in the direction parallel to the tensioning direction of the tensioning element.

30. The driving mechanism for the traction-exerting component according to claim 1, wherein in addition to the driving wheel, at least one of the tensioning wheels and/or the additional reversing wheel are driven.

31. The driving mechanism for the traction-exerting component according to claim 1, wherein the traction-exerting component is formed by a chain, cable, belt or band.

32. A conveyor device for transporting piece goods along a transport line via a traction-exerting component with at least one driving mechanism for the latter, wherein the driving mechanism for the traction-exerting component particularly for a conveyor device comprises a frame; at least one reversing wheel and at least one driving wheel supported on said frame; an endlessly revolving, flexible traction-exerting component reversible with respect to the direction of revolution and guided around said reversing and driving wheels and having a pulled strand and a returning strand; a tensioning device; as well as at least one setting element, said tensioning device comprising two support bodies arranged one behind the other in the direction of revolution of the traction-exerting component and being adjustable relative to one another, as well as tensioning elements supported on said support bodies, whereby tensioning forces directed against each other are admissible to the tensioning elements, and the traction-exerting component is guided with its pulled strand around one of the tensioning elements, and with its returning strand around the other tensioning element, as well as around the reversing wheel and the driving wheel and/or at least one additional reversing wheel supported on the frame, and whereby the support bodies are coupled with each other in terms of movement via the setting element.
